(19) United States
(12) Patent Application Publication
(10) Pub. No.: US 2026/0112113 A1
(43) Pub. Date: Apr. 23, 2026

(54) METHOD AND SYSTEM FOR ANALYZING THE POTENTIAL OF SPATIAL INCREMENTAL CAPACITY OF HISTORIC TOWNSCAPE CONSERVATION AREAS

(71) Applicant: SOUTHEAST UNIVERSITY, Nanjing (CN)

(72) Inventors: Dongqing HAN, Nanjing (CN); Yaoxuan WANG, Nanjing (CN); Yacheng SONG, Nanjing (CN); Yinan DONG, Nanjing (CN); Zhiyu PANG, Nanjing (CN)

(73) Assignee: SOUTHEAST UNIVERSITY, Nanjing (CN)

(21) Appl. No.: 19/117,093

(22) PCT Filed: Mar. 14, 2024
(86) PCT No.: PCT/CN2024/081628

§ 371 Date: Oct. 30, 2025

(30) Foreign Application Priority Data
Nov. 21, 2023 (CN) 202311554299.0

(51) Int. Cl. G06T 17/10; G06F 30/13; G06F 30/20; G06F 111/04; G06Q 50/26

(52) U.S. Cl. CPC G06T 17/10; G06F 30/13; G06F 30/20; G06Q 50/26; G06F 2111/04

(57) ABSTRACT

A method and system for analyzing the potential of spatial incremental capacity of historic townscape conservation areas relates to the field of townscape conservation area renewal. The method includes: inputting an urban area to be researched, and delineating a block within the area that requires incremental capacity research; determining influential solar constraint and visual constraint around the block for incremental capacity research, and generating a three-dimensional model in blocks; generating a solar envelope of the urban area based on the solar constraint, and generating a visual envelope of the urban area based on the visual constraint; performing intersection processing on the solar envelope and the visual envelope to generate a height controlled planar gradient map; predicting a potential texture form based on the height controlled planar gradient map, and quantitatively presenting the potential texture form to obtain adjusted data indicators of the block.

### CROSS-REFERENCE TO THE RELATED APPLICATIONS

This application is the national phase entry of International Application No. PCT/CN2024/081628, filed on Mar. 14, 2024, which is based upon and claims priority to Chinese Patent Application No. 202311554299.0, filed on Nov. 21, 2023, the entire contents of which are incorporated herein by reference.

### TECHNICAL FIELD

The present invention relates to the technical field of townscape conservation area renewal, in particular to a method and system for analyzing the potential of spatial incremental capacity of historic townscape conservation areas.

### BACKGROUND

When urban areas in high-density built environments are renewed, designers often design based on construction height control in planning and design. However, the height control in planning is often carried out in a one-size-fits-all manner by block basis, which may result in a significant difference in constructible height between two adjacent blocks, reaching tens or even hundreds of meters. This is not conducive to the establishment of a good townscape and may also sacrifice the potential of spatial incremental capacity of some blocks. In addition, people have different visual perceptions of street outlines and internal blocks, the same control principle should not be applied to them, and there is still room for capacity increase inside the blocks. On the other hand, the high-density built environments are complex. In the process of urban renewal, designers'arbitrary capacity increase may affect the solar environment of surrounding residential areas. Therefore, precise analysis methods are required for effective quantitative analysis on solar and visual constraints in designed blocks.

### SUMMARY

### (1) Technical Problem to be Solved

In view of the shortcomings of the prior art, the present invention provides a method and system for analyzing the potential of spatial incremental capacity of historic townscape conservation areas, which solve the problem that precise analysis methods are required in the prior art for effective quantitative analysis on solar and visual constraints in designed blocks.

### (2) Technical Solution

To achieve the above objective, the present invention is implemented through the following technical solution:

In a first aspect, a method for analyzing the potential of spatial incremental capacity of historic townscape conservation areas is provided, including:
inputting an urban area to be researched, and delineating a block within the area that requires incremental capacity research;
determining influential solar constraint and visual constraint around the block for incremental capacity research, and generating a three-dimensional model in blocks;
generating a solar envelope of the urban area based on the solar constraint, and generating a visual envelope of the urban area based on the visual constraint;
performing intersection processing on the solar envelope and the visual envelope to obtain a constructible area within a research scope, and then performing gradient fitting on the intersected envelope to generate a height controlled planar gradient map; and
predicting a potential texture form based on the height controlled planar gradient map, and quantitatively presenting the potential texture form to obtain adjusted data indicators of the block.

Preferably, the solar constraint includes solar requirements of surrounding residential buildings affected by the construction in a site.

Preferably, the solar constraint meets the requirement that the surrounding residential buildings have at least 2 hours of full-window sunshine on the winter solstice, a solar influential constraint group is set as obstacles, and boundaries of the researched block are input into geometry to generate the solar envelope.

Preferably, the solar envelope is generated by programming through a Grasshopper-based visual programming platform and a Ladybug analysis plug-in as follows:
obtaining standard annual meteorological data of a city where the site to be researched is located, importing the meteorological data into a climate import module of a Ladybug plug-in system in Grasshopper, and importing geographical location information in the meteorological data into a sunpath module using a climate analysis tool in the Ladybug plug-in;
generating an annular sunpath on the analysis site using the sunpath module, setting solar duration required by the surrounding solar influential constraint, generating a sunpath on the research site within the solar duration, and importing generated solar vector information into a solar envelope module of the Ladybug;
importing a solar vector generated in the previous step, the contour boundaries of the block to be analyzed, and the surrounding solar influential constraint into the solar envelope module, setting an analysis grid scale, defining a solar envelope mode as a solar rights mode, and setting the solar envelope mode for running to generate a maximum construction height plane that can ensure the solar duration of the surrounding solar influential constraint in the site to be researched; and
importing maximum construction height plane dot matrix information obtained by analyzing the solar envelope into a patch module of the Grasshopper to generate a curved surface, extruding the curved surface towards a-z axis direction by one length to generate a solid comprising ground space of the entire analysis site, and then extruding the boundaries of the block within the analysis scope towards a z axis direction by one length to generate a solid exceeding the maximum construction height plane; performing intersection processing on the two solids to generate the solar envelope.

Preferably, the visual constraint includes constraint or historic resource points that are outside the site and have visual requirements.

Preferably, the visual envelope is generated by the following steps:
determining visual control constraint around the analysis site, and designing and determining a visual control mode, where the visual control constraint includes streets, protected buildings, and public green spaces; and
generating a three-dimensional visual control area model based on the determined visual control constraint and control mode, and generating the visual envelope based on the three-dimensional visual control area model.

Preferably, the data indicators include building area, building density, and block ratio.

In a second aspect, a system for analyzing the potential of spatial incremental capacity of historic townscape conservation areas is provided, including the following modules:
an input module, configured to input an urban area to be researched, and delineate a block within the area that requires incremental capacity research;
a determination module, configured to determine influential solar constraint and visual constraint around the block for incremental capacity research, and generate a three-dimensional model in blocks;
a generation module, configured to generate a solar envelope of the urban area based on the solar constraint, and generate a visual envelope of the urban area based on the visual constraint;
a processing module, configured to perform intersection processing on the solar envelope and the visual envelope to obtain a constructible area within a research scope, and then perform gradient fitting on the intersected envelope to generate a height controlled planar gradient map; and
an output module, configured to predict a potential texture form based on the height controlled planar gradient map, and quantitatively present the potential texture form to obtain adjusted data indicators of the block.

In a third aspect, a computer-readable storage medium storing one or more programs is provided, where the one or more programs include instructions that, when executed by a computing device, enable the computing device to perform any of the mentioned methods.

In a fourth aspect, a computing device is provided, including:
one or more processors, a memory, and one or more programs, where the one or more programs are stored in the memory and configured to be executed by the one or more processors, and the one or more programs include instructions used for performing any of the mentioned methods.

### (3) Beneficial Effects

In view of the problem mentioned in the background that effective basis for spatial incremental capacity lacks because the impact of solar and visual constraints on a design site is difficult to quantitatively analyze in urban renewal design with townscape control requirements, the present invention provides a digital analysis method for a capacity increasable space based on solar and visual impact determination in townscape conservation area renewal, which can achieve digital quantitative analysis on solar and visual constraints in a design stage and generate a three-dimensional envelope of a constructible area, thereby providing designers with more precise height control determination basis.

### BRIEF DESCRIPTION OF THE DRAWINGS

FIG. 1 is a flowchart of a method for analyzing the potential of spatial incremental capacity of historic townscape conservation areas in the present invention;

FIG. 2 is a diagram of an analysis and research site and surrounding influential constraints in an embodiment of the present invention;

FIG. 3 is a diagram of a solar envelope generating program in an embodiment of the present invention;

FIG. 4 is a diagram of a solar envelope generated in an embodiment of the present invention;

FIG. 5 is a diagram of a visual control envelope in an embodiment of the present invention;

FIG. 6 is a schematic diagram of a visual control condition in an embodiment of the present invention;

FIG. 7 is a diagram of a visual control constructible envelope in an embodiment of the present invention; and

FIG. 8 is a diagram of gradient processing of a solar-visual control constructible envelope in an embodiment of the present invention.

### DETAILED DESCRIPTION OF THE EMBODIMENTS

The technical solutions in the embodiments of the present invention will be clearly and completely described below with reference to the accompanying drawings in the present invention. Apparently, the described embodiments are only some, not all of the embodiments of the present invention. All other embodiments obtained by those of ordinary skill in the art based on the embodiments of the present invention without any creative efforts shall fall within the scope of protection of the present invention.

### Embodiment

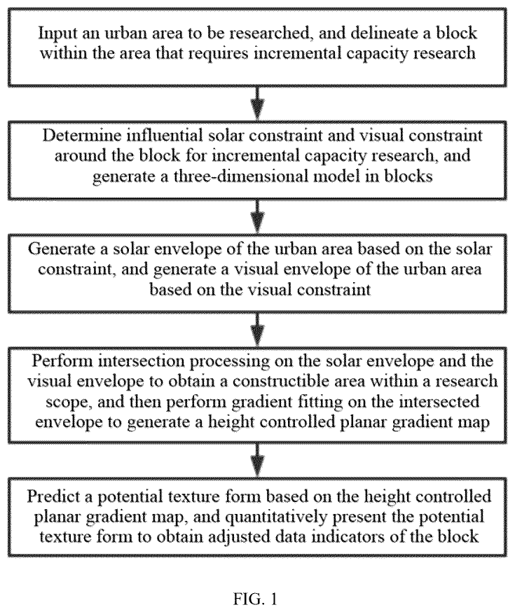

As shown in FIG. 1, an embodiment of the present invention provides a method for analyzing the potential of spatial incremental capacity of historic townscape conservation areas, including:
inputting an urban area to be researched, and delineating a block within the area that requires incremental capacity research;
determining influential solar constraint and visual constraint around the block for incremental capacity research, and generating a three-dimensional model in blocks;
generating a solar envelope of the urban area based on the solar constraint, and generating a visual envelope of the urban area based on the visual constraint;
performing intersection processing on the solar envelope and the visual envelope to obtain a constructible area within a research scope, and then performing gradient fitting on the intersected envelope to generate a height controlled planar gradient map; and
reversely deducting a potential texture form based on the height controlled planar gradient map, and quantitatively presenting the potential texture form to obtain adjusted data indicators of the block.

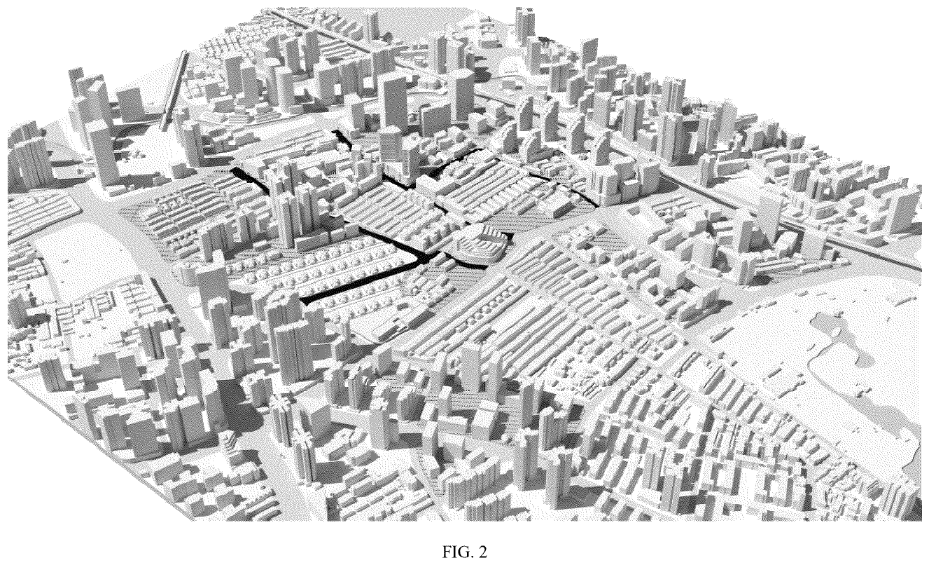

As shown in FIG. 2, the site is a townscape conservation area with rich architectural forms and textures inside. The potential of incremental capacity of the block filled with diagonal lines in the diagram is now analyzed. Residential functional blocks are scattered around the block to be analyzed. The research and analysis should ensure that the surrounding residential blocks have at least 2 hours of sunshine at noon on the winter solstice after incremental capacity construction. Meanwhile, there are several townscape conservation roads (black marked roads) in the site. It should ensure that pedestrians can see the sky at a maximum elevation angle (45°) when looking at a street interface vertically on two sides of a street.

Further, the solar constraint includes solar requirements of surrounding residential buildings affected by the construction in a site.

Further, the solar constraint meets the requirement that the surrounding residential buildings have at least 2 hours of full-window sunshine on the winter solstice, a solar influential constraint group is set as obstacles, and boundaries of the researched block are input into geometry to generate the solar envelope.

Further, the solar envelope is generated by programming through a Grasshopper-based visual programming platform and a Ladybug analysis plug-in as follows:

Standard annual meteorological data of a city where the site is located is downloaded from a climate database on the official Energplus website. The meteorological data is imported into a climate import module (Import EPW) of a Ladybug plug-in system in Grasshopper. Geographical location information in the meteorological data is imported into a sunpath module using a climate analysis tool in the Ladybug plug-in.

An annular sunpath on the analysis site is generated using the sunpath module. Solar duration required by the surrounding solar influential constraint (such as 11:00 to 13:00 on the winter solstice) is set, a sunpath on the research site within the duration is generated, and generated solar vector information is imported into a solar envelope module of the Ladybug.

A solar vector generated in the previous step, the contour boundaries of the block to be analyzed, and the surrounding solar influential constraint (such as an underside of surrounding blocks or windows of surrounding buildings) are imported into the solar envelope module, an analysis grid scale is set, and a solar envelope mode is defined as a solar rights mode and set for running to generate a maximum construction height plane that can ensure the solar duration of the surrounding solar influential constraint in the analysis site.

A solar influential envelope is generated. Maximum construction height plane dot matrix information obtained by analyzing the solar envelope is imported into a patch module of the Grasshopper to generate a curved surface, the curved surface is extruded towards a-z axis direction by one length to generate a solid including ground space of the entire analysis site, and then the boundaries of the block within the analysis scope are extruded towards a z axis direction by one length to generate a solid exceeding the maximum construction height plane. Intersection processing is performed on the two solids to generate the final solar influential envelope.

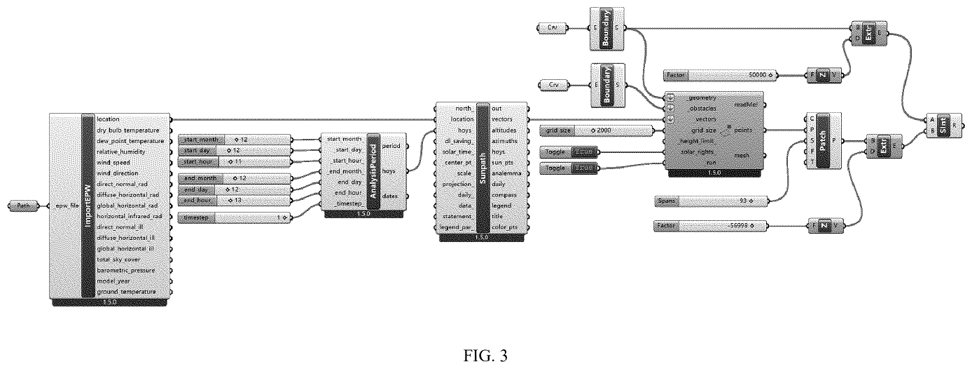

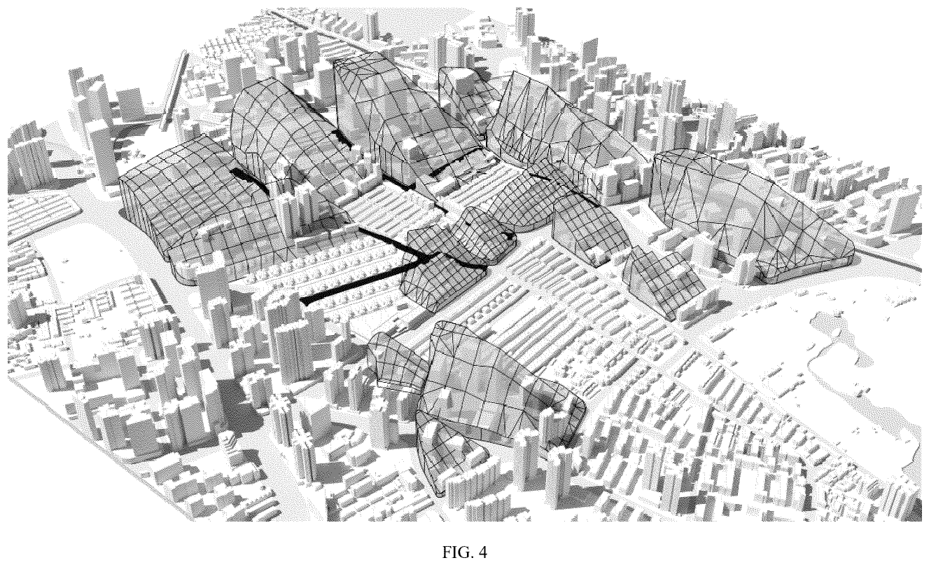

FIG. 3 shows a solar envelope generating program. According to the surrounding condition of the block to be analyzed, its solar influential constraint is a standard solar condition for surrounding residential buildings, which should meet the requirement that the surrounding residential buildings have at least 2 hours of full-window sunlight on the winter solstice. A solar influential constraint group is set as obstacles, and then the boundaries of the analyzed block are input into geometry to generate the solar influential envelope, as shown in FIG. 4.

Further, the visual constraint includes constraint or historic resource points that are outside the site and have visual requirements.

Further, the visual envelope is generated by the following steps:

Visual control constraint around the analysis site (such as streets, protected buildings, and public green spaces) is determined, and a visual control mode is designed and determined. For example, on a townscape conservation road, pedestrians can see the sky at a maximum elevation angle when looking at a street interface vertically on two sides of a street. Alternatively, important visual control constraint around the site can show townscape resource points (such as protected buildings) inside and outside the site to form a visual corridor. Less visual control is explicitly stipulated in planning regulations, so the control mode can be designed and determined by designers.

A three-dimensional visual control area model is generated based on the determined visual control constraint and control mode.

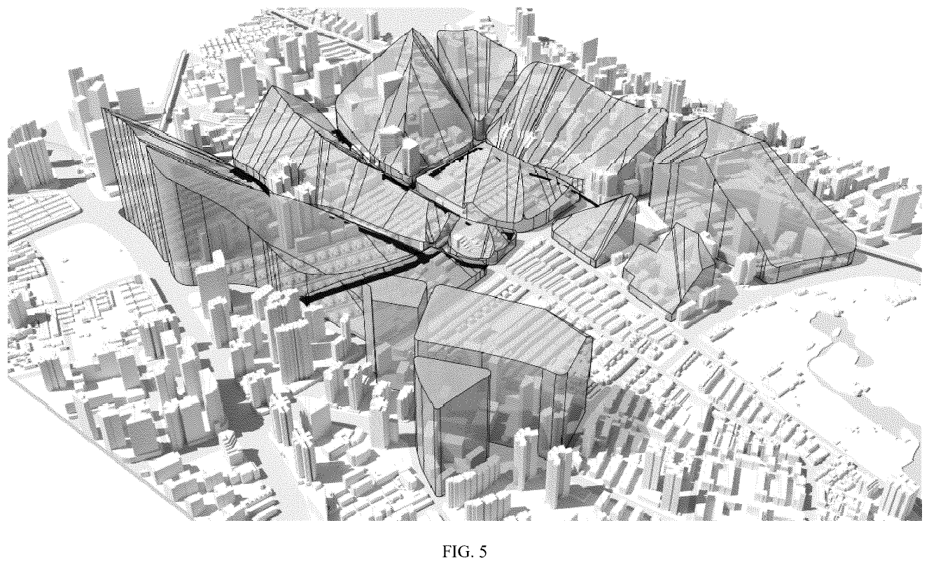

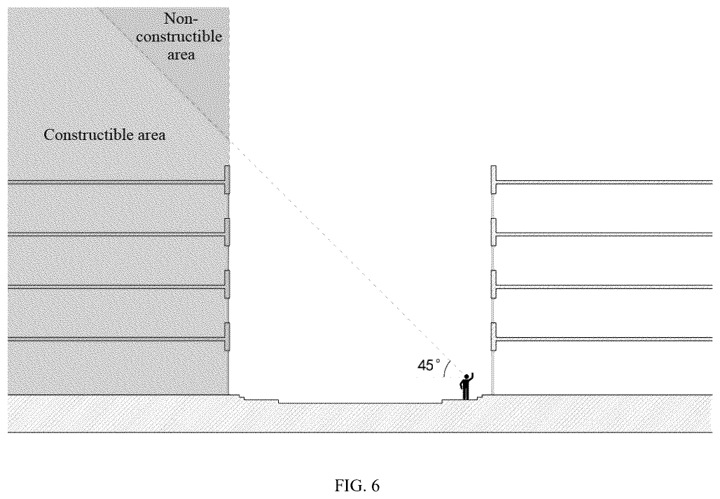

As shown in FIG. 5, there are several townscape conservation roads around the block to be analyzed. The design requires that pedestrians can see the sky at a maximum elevation angle (45°) when looking at a street interface of the analysis site vertically from the outside of a street, as shown in FIG. 6. Then, in three-dimensional modeling software, left and right blocks of the road are used as the base to form a 45°trapezoidal solid by layout, and Boolean operation cut-off is performed on this solid and an overhead solid of the analysis site to obtain a constructible area constrained by the condition in the site, namely, a visual control envelope.

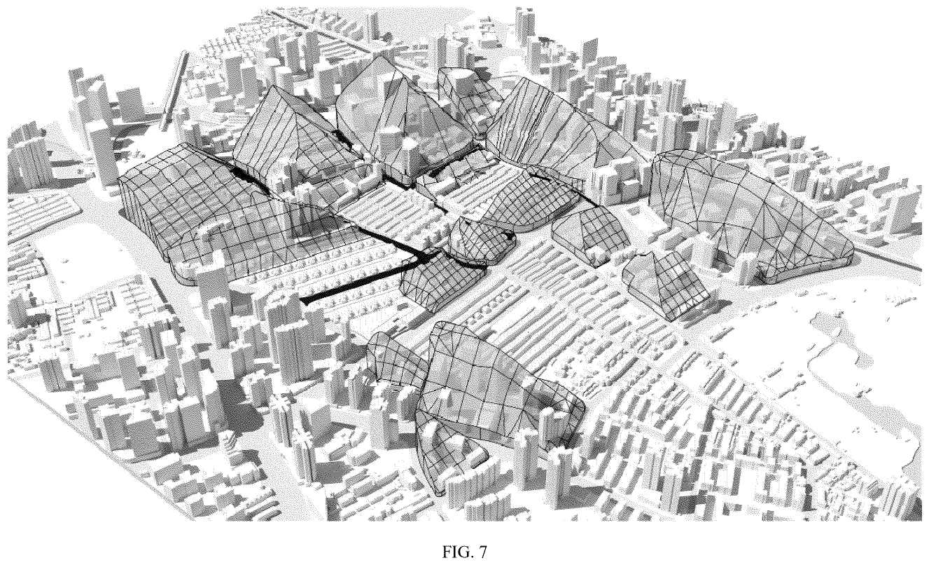

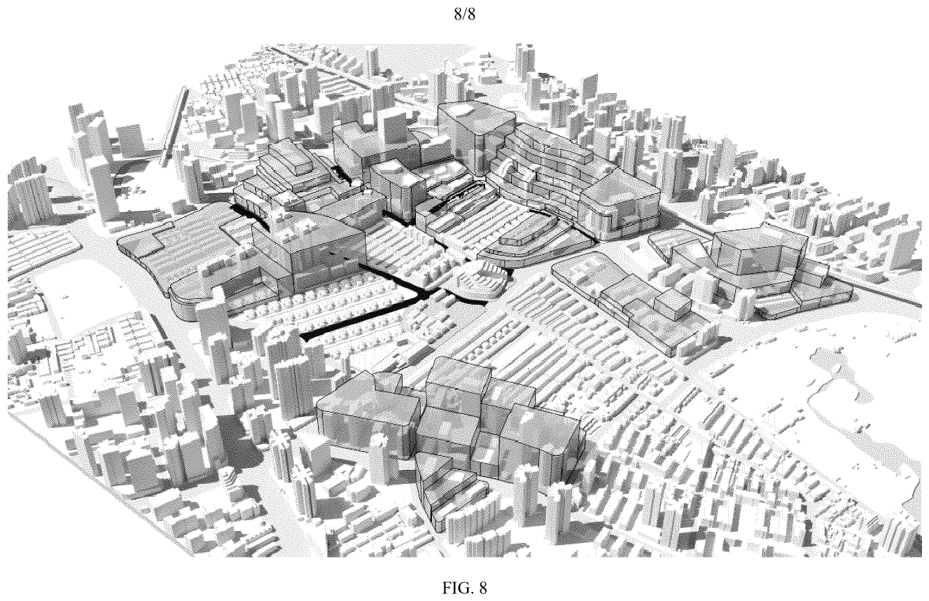

Boolean operation intersection processing is performed on the obtained solar control envelope and visual control envelope to obtain a constructible envelope of the analysis area that meets both solar and visual requirements, as shown in FIG. 7. An appropriate gradient size is set, and the envelope is fitted into a step form, as shown in FIG. 8. As such, a height control plan suitable for planning and control can be drawn.

Further, the data indicators include building area, building density, and block ratio.

Finally, a potential texture form is predicted based on the generated envelope by referring to the patent Form Type-Based Digital Generation Method for Building Solids in Urban Design with publication number CN115292789B, and quantitatively presented to obtain corresponding data indicators such as building area, building density, and block ratio. The indicators are compared with existing plans to further help the designers grasp the potential and possible ways to increase the capacity of the research block.

Another embodiment of the present invention provides a system for analyzing the potential of spatial incremental capacity of historic townscape conservation areas, including the following modules:
an input module, configured to input an urban area to be researched, and delineate a block within the area that requires incremental capacity research;
a determination module, configured to determine influential solar constraint and visual constraint around the block for incremental capacity research, and generate a three-dimensional model in blocks;
a generation module, configured to generate a solar envelope of the urban area based on the solar constraint, and generate a visual envelope of the urban area based on the visual constraint;
a processing module, configured to perform intersection processing on the solar envelope and the visual envelope to obtain a constructible area within a research scope, and then perform gradient fitting on the intersected envelope to generate a height controlled planar gradient map; and
an output module, configured to predict a potential texture form based on the height controlled planar gradient map, and quantitatively present the potential texture form to obtain adjusted data indicators of the block.

The embodiments of the present application may be provided as a method or a computer program product. Therefore, the present application may be in a form of full hardware embodiments, full software embodiments, or software and hardware embodiments. Moreover, the present application may be in a form of a computer program product implemented on one or more computer-usable storage media (including but not limited to a disk memory, a CD-ROM, an optical memory, and the like) that include computer-usable program code. The solutions in the embodiments of the present application may be implemented in various computer languages, such as object-oriented programming language Java and literal scripting language JavaScript.

The present application is described with reference to flowcharts and/or block diagrams of the method, the device (system), and the computer program product in the embodiments of the present application. It should be understood that computer program instructions may be used to implement each process and/or block in the flowcharts and/or block diagrams, or a combination of processes and/or blocks in the flowcharts and/or block diagrams. These computer program instructions may be provided to a general-purpose computer, a special-purpose computer, an embedded processor, or a processor of other programmable data processing device to generate a machine, so that the instructions executed by the computer or the processor of the other programmable data processing device generate an apparatus for implementing a specified function in one or more processes in the flowcharts and/or in one or more blocks in the block diagrams.

These computer program instructions may also be stored in a computer-readable memory that can guide a computer or other programmable data processing device to work in a specific manner, so that the instructions stored in the computer-readable memory generate a product including an instruction apparatus, where the instruction apparatus implements functions specified in one or more processes in the flowcharts and/or one or more blocks in the block diagrams.

These computer program instructions may also be loaded into a computer or other programmable data processing device, so that a series of operation steps are performed on the computer or other programmable data processing device to generate processing implemented by a computer, and instructions executed on the computer or other programmable data processing device provide steps for implementing functions specified in one or more processes in the flowcharts and/or one or more blocks in the block diagrams.

It should be noted that the relationship terms herein, such as first and second, are merely used for distinguishing one entity or operation from another, and do not necessarily require or imply that any actual relationship or sequence exists between these entities or operations. Moreover, the terms “include”, “comprise”, and any variants thereof are intended to cover a non-exclusive inclusion, such that a process, method, article, or device including a series of elements not only includes those elements, but further includes other elements not listed explicitly, or includes inherent elements of the process, method, article, or device. In the absence of more limitations, an element defined by “include a.” does not exclude other same elements existing in the process, method, article, or device including the element.

What is claimed is:

1. A method for analyzing a potential of spatial incremental capacity of historic townscape conservation areas, comprising:
inputting an urban area to be researched, and delineating a block within the urban area that requires incremental capacity research;
determining influential solar constraint and visual constraint around the block for incremental capacity research, and generating a three-dimensional model in blocks;
generating a solar envelope of the urban area based on the solar constraint, and generating a visual envelope of the urban area based on the visual constraint;
performing intersection processing on the solar envelope and the visual envelope to obtain a constructible area within a research scope, and then performing gradient fitting on the intersected envelope to generate a height controlled planar gradient map; and
predicting a potential texture form based on the height controlled planar gradient map, and quantitatively presenting the potential texture form to obtain adjusted data indicators of the block.

2. The method for analyzing the potential of spatial incremental capacity of historic townscape conservation areas according to claim 1, wherein the solar constraint comprises solar requirements of surrounding residential buildings affected by a construction in a site.

3. The method for analyzing the potential of spatial incremental capacity of historic townscape conservation areas according to claim 2, wherein the solar constraint meets the requirement that the surrounding residential buildings have at least 2 hours of full-window sunshine on the winter solstice, a solar influential constraint group is set as obstacles, and boundaries of the researched block are input into geometry to generate the solar envelope.

4. The method for analyzing the potential of spatial incremental capacity of historic townscape conservation areas according to claim 3, wherein the solar envelope is generated by programming through a Grasshopper-based visual programming platform and a Ladybug analysis plug-in as follows:
obtaining standard annual meteorological data of a city where the urban area to be researched is located, importing the meteorological data into a climate import module of a Ladybug plug-in system in Grasshopper, and importing geographical location information in the meteorological data into a sunpath module using a climate analysis tool in the Ladybug plug-in;
generating an annular sunpath on an analysis site using the sunpath module, setting a solar duration required by the surrounding solar influential constraint, generating a sunpath on a research site within the solar duration, and importing generated solar vector information into a solar envelope module of the Ladybug;
importing a solar vector generated in the previous step, the contour boundaries of the block to be analyzed, and the surrounding solar influential constraint into the solar envelope module, setting an analysis grid scale, defining a solar envelope mode as a solar rights mode, and setting the solar envelope mode for running to generate a maximum construction height plane that can ensure the solar duration of the surrounding solar influential constraint in the urban area to be researched; and
importing maximum construction height plane dot matrix information obtained by analyzing the solar envelope into a patch module of the Grasshopper to generate a curved surface, extruding the curved surface towards a-z axis direction by one length to generate a solid comprising ground space of the entire analysis site, and then extruding the boundaries of the block within an analysis scope towards a z axis direction by one length to generate a solid exceeding the maximum construction height plane; and performing intersection processing on the two solids to generate the solar envelope.

5. The method for analyzing the potential of spatial incremental capacity of historic townscape conservation areas according to claim 1, wherein the visual constraint comprises constraint or historic resource points that are outside the site and have visual requirements.

6. The method for analyzing the potential of spatial incremental capacity of historic townscape conservation areas according to claim 5, wherein the visual envelope is generated by the following steps:
determining visual control constraint around the analyzed urban area, and designing and determining a visual control mode, wherein the visual control constraint comprises streets, protected buildings, and public green spaces; and
generating a three-dimensional visual control area model based on the determined visual control constraint and control mode, and generating the visual envelope based on the three-dimensional visual control area model.

7. The method for analyzing the potential of spatial incremental capacity of historic townscape conservation areas according to claim 1, wherein the data indicators comprise building area, building density, and block ratio.

8. A system for analyzing a potential of spatial incremental capacity of historic townscape conservation areas, comprising the following modules:
an input module, configured to input an urban area to be researched, and delineate a block within the urban area that requires incremental capacity research;
a determination module, configured to determine influential solar constraint and visual constraint around the block for incremental capacity research, and generate a three-dimensional model in blocks;
a generation module, configured to generate a solar envelope of the urban area based on the solar constraint, and generate a visual envelope of the urban area based on the visual constraint;
a processing module, configured to perform intersection processing on the solar envelope and the visual envelope to obtain a constructible area within a research scope, and then perform gradient fitting on the intersected envelope to generate a height controlled planar gradient map; and
an output module, configured to predict a potential texture form based on the height controlled planar gradient map, and quantitatively present the potential texture form to obtain adjusted data indicators of the block.

9. A computer-readable storage medium storing one or more programs, wherein the one or more programs comprise instructions that, when executed by a computing device, enable the computing device to perform the method according to claim 1.

10. A computing device, comprising:
one or more processors, a memory, and one or more programs, wherein the one or more programs are stored in the memory and configured to be executed by the one or more processors, and the one or more programs comprise instructions used for performing the method according to claim 1.

11. The computer-readable storage medium according to claim 9, wherein in the method for analyzing the potential of spatial incremental capacity of historic townscape conservation areas, the solar constraint comprises solar requirements of surrounding residential buildings affected by a construction in a site.

12. The computer-readable storage medium according to claim 11, wherein in the method for analyzing the potential of spatial incremental capacity of historic townscape conservation areas, the solar constraint meets the requirement that the surrounding residential buildings have at least 2 hours of full-window sunshine on the winter solstice, a solar influential constraint group is set as obstacles, and boundaries of the researched block are input into geometry to generate the solar envelope.

13. The computer-readable storage medium according to claim 12, wherein in the method for analyzing the potential of spatial incremental capacity of historic townscape conservation areas, the solar envelope is generated by programming through a Grasshopper-based visual programming platform and a Ladybug analysis plug-in as follows:
obtaining standard annual meteorological data of a city where the urban area to be researched is located, importing the meteorological data into a climate import module of a Ladybug plug-in system in Grasshopper, and importing geographical location information in the meteorological data into a sunpath module using a climate analysis tool in the Ladybug plug-in;
generating an annular sunpath on an analysis site using the sunpath module, setting a solar duration required by the surrounding solar influential constraint, generating a sunpath on a research site within the solar duration, and importing generated solar vector information into a solar envelope module of the Ladybug;
importing a solar vector generated in the previous step, the contour boundaries of the block to be analyzed, and the surrounding solar influential constraint into the solar envelope module, setting an analysis grid scale, defining a solar envelope mode as a solar rights mode, and setting the solar envelope mode for running to generate a maximum construction height plane that can ensure the solar duration of the surrounding solar influential constraint in the urban area to be researched; and
importing maximum construction height plane dot matrix information obtained by analyzing the solar envelope into a patch module of the Grasshopper to generate a curved surface, extruding the curved surface towards a-z axis direction by one length to generate a solid comprising ground space of the entire analysis site, and then extruding the boundaries of the block within an analysis scope towards a z axis direction by one length to generate a solid exceeding the maximum construction height plane; and performing intersection processing on the two solids to generate the solar envelope.

14. The computer-readable storage medium according to claim 9, wherein in the method for analyzing the potential of spatial incremental capacity of historic townscape conservation areas, the visual constraint comprises constraint or historic resource points that are outside the site and have visual requirements.

15. The computer-readable storage medium according to claim 14, wherein in the method for analyzing the potential of spatial incremental capacity of historic townscape conservation areas, the visual envelope is generated by the following steps:
determining visual control constraint around the analyzed urban area, and designing and determining a visual control mode, wherein the visual control constraint comprises streets, protected buildings, and public green spaces; and
generating a three-dimensional visual control area model based on the determined visual control constraint and control mode, and generating the visual envelope based on the three-dimensional visual control area model.

16. The computer-readable storage medium according to claim 9, wherein in the method for analyzing the potential of spatial incremental capacity of historic townscape conservation areas, the data indicators comprise building area, building density, and block ratio.

17. The computing device according to claim 10, wherein in the method for analyzing the potential of spatial incremental capacity of historic townscape conservation areas, the solar constraint comprises solar requirements of surrounding residential buildings affected by a construction in a site.

18. The computing device according to claim 17, wherein in the method for analyzing the potential of spatial incremental capacity of historic townscape conservation areas, the solar constraint meets the requirement that the surrounding residential buildings have at least 2 hours of full-window sunshine on the winter solstice, a solar influential constraint group is set as obstacles, and boundaries of the researched block are input into geometry to generate the solar envelope.

19. The computing device according to claim 18, wherein in the method for analyzing the potential of spatial incremental capacity of historic townscape conservation areas, the solar envelope is generated by programming through a Grasshopper-based visual programming platform and a Ladybug analysis plug-in as follows:
obtaining standard annual meteorological data of a city where the urban area to be researched is located, importing the meteorological data into a climate import module of a Ladybug plug-in system in Grasshopper, and importing geographical location information in the meteorological data into a sunpath module using a climate analysis tool in the Ladybug plug-in;
generating an annular sunpath on an analysis site using the sunpath module, setting a solar duration required by the surrounding solar influential constraint, generating a sunpath on a research site within the solar duration, and importing generated solar vector information into a solar envelope module of the Ladybug;
importing a solar vector generated in the previous step, the contour boundaries of the block to be analyzed, and the surrounding solar influential constraint into the solar envelope module, setting an analysis grid scale, defining a solar envelope mode as a solar rights mode, and setting the solar envelope mode for running to generate a maximum construction height plane that can ensure the solar duration of the surrounding solar influential constraint in the urban area to be researched; and
importing maximum construction height plane dot matrix information obtained by analyzing the solar envelope into a patch module of the Grasshopper to generate a curved surface, extruding the curved surface towards a-z axis direction by one length to generate a solid comprising ground space of the entire analysis site, and then extruding the boundaries of the block within an analysis scope towards a z axis direction by one length to generate a solid exceeding the maximum construction height plane; and performing intersection processing on the two solids to generate the solar envelope.

20. The computing device according to claim 10, wherein in the method for analyzing the potential of spatial incremental capacity of historic townscape conservation areas, the visual constraint comprises constraint or historic resource points that are outside the site and have visual requirements.
